(19) United States
(12) Patent Application Publication
(10) Pub. No.: US 2022/0244725 A1
(43) Pub. Date: Aug. 4, 2022

(54) AUTONOMOUS TRAILING LOGISTICAL SUPPORT VEHICLE

(71) Applicant: GM Cruise Holdings, LLC, San Francisco, CA (US)

(72) Inventors: Dogan Gidon, Berkeley, CA (US); Nestor Grace, San Francisco, CA (US); Diego Plascencia-Vega, San Francisco, CA (US)

(21) Appl. No.: 17/167,572

(22) Filed: Feb. 4, 2021

(51) Int. Cl. G05D 1/00; G05D 1/02

(52) U.S. Cl. CPC G05D 1/0027; G05D 1/0088; G05D 1/0246; G05D 1/0214

(57) ABSTRACT

The subject disclosure relates to techniques for a logistical support autonomous vehicle. A process of the disclosed technology can include receiving, at an autonomous vehicle (AV), a support request, in response to the follow-along routing preference specified by the user, determining a location of the user, and navigating the AV so that the AV remains positioned within a threshold distance of the user. Systems and machine-readable media are also provided.

### BACKGROUND

### 1. Technical Field

The subject technology provides solutions for a logistical support vehicle and more particularly, to a logistical support vehicle configured to navigate based on a follow along and/or flexible routing preference.

### 2. Introduction

Currently, when people want to carry materials, equipment, or other items that do not fit in their vehicle, they would have to either hitch a trailer that they would then need to tow or rely on services of others for end-to-end delivery.

### BRIEF DESCRIPTION OF THE DRAWINGS

Certain features of the subject technology are set forth in the appended claims. However, the accompanying drawings, which are included to provide further understanding, illustrate disclosed aspects and together with the description serve to explain the principles of the subject technology. In the drawings:

FIG. 1 illustrates an environment having an autonomous vehicle fulfilling a support request with a follow along routing preference according to an example of the instant disclosure.

FIG. 2 is a flowchart of a method for autonomous vehicle navigation based on a follow along routing preference according to an example of the instant disclosure.

FIG. 3 illustrates an environment having an autonomous vehicle fulfilling a support request with a flexible routing preference according to an example of the instant disclosure.

FIG. 4 illustrates autonomous vehicle navigation based on a flexible routing preference according to an example of the instant disclosure.

FIG. 5 illustrates environment that includes an autonomous vehicle in communication with a computing system according to an example of the instant disclosure.

FIG. 6 shows an example of a system for implementing certain aspects of the present technology according to an example of the instant disclosure.

### DETAILED DESCRIPTION

The detailed description set forth below is intended as a description of various configurations of the subject technology and is not intended to represent the only configurations in which the subject technology can be practiced. The appended drawings are incorporated herein and constitute a part of the detailed description. The detailed description includes specific details for the purpose of providing a more thorough understanding of the subject technology. However, it will be clear and apparent that the subject technology is not limited to the specific details set forth herein and may be practiced without these details. In some instances, structures and components are shown in block diagram form in order to avoid obscuring the concepts of the subject technology.

As described herein, one aspect of the present technology is the gathering and use of data available from various sources to improve quality and experience. The present disclosure contemplates that in some instances, this gathered data may include personal information. The present disclosure contemplates that the entities involved with such personal information respect and value privacy policies and practices.

Currently, when people want to carry materials, equipment, or other items that do not fit in their vehicle, they would have to either hitch a trailer that they would then need to tow or rely on services of others for end-to-end delivery. For those that choose to hitch a trailer, the users must then spend additional energy to manage their trailers. For example, they may physically tow a trailer on a bicycle or require a vehicle with more power to tow heavier trailers. For those that elect to hire delivery services, the users would lose access to their items during the delivery, which is a large loss of flexibility for the users.

Accordingly, aspects of the disclosed technology address the limitations of conventional logistical support. More specifically, an autonomous vehicle can be configured to operate as a logistical support unit. Furthermore, the autonomous vehicle can be configured to navigate based on a follow along preference and/or a flexible routing preference specified by a user. Additionally, the autonomous vehicle can receive intercept or meeting requests and navigate, in response to the request, to a meeting location to rendezvous with the user.

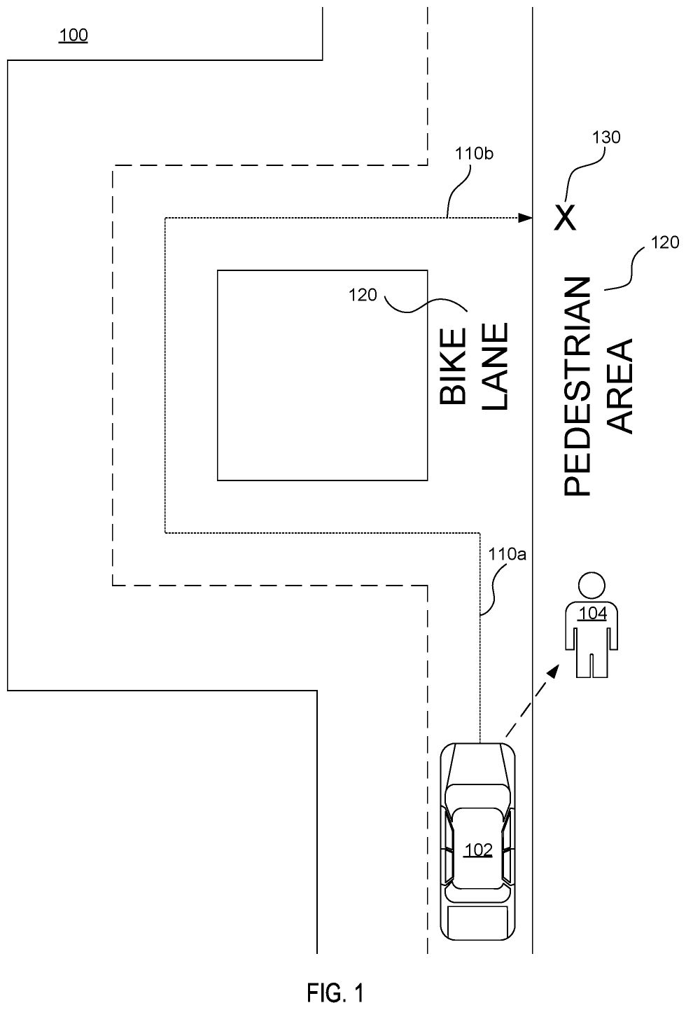

FIG. 1 illustrates an environment 100 having an autonomous vehicle 102 and a user 104. User 104 may request use of autonomous vehicle 102 for logistical support. For example, user 104 may desire to utilize autonomous vehicle 102 as a trailer or follow along vehicle, vehicle for moving items, etc. The user 104 can send the request via a user device having a ridesharing app (e.g., ridesharing app 570). A remote computing system (e.g., remote computing system 550) can receive the request (e.g., via rideshare service 558) and dispatch a suitable autonomous vehicle, such as autonomous vehicle 102. In some embodiments, autonomous vehicle 102 can be one autonomous vehicle in an autonomous vehicle fleet. Furthermore, the autonomous vehicle fleet can have various different models of autonomous vehicles, so that one or more autonomous vehicle models can be suitable for various user requests based on cabin size, storage size, distance from a start point to a destination, etc. Autonomous vehicle 102 can then receive the request and navigate to the start point and/or user 104.

The request can specify a follow along preference. The follow along preference can be configured to cause autonomous vehicle 102 to follow user 104. Furthermore, the follow along preference can specify a threshold distance that autonomous vehicle 102 should remain within from user 104. Autonomous vehicle 102 can then navigate and remain positioned within the threshold distance from user 104. For example, a bike riding user 104 may request that autonomous vehicle 102 remain positioned within 1,000 feet from the user. As another example, a user 104 driving another vehicle can similarly request that autonomous vehicle 102 remain within one mile from the user.

As further shown in FIG. 1, autonomous vehicle 102 can be configured to follow user 104 along a first portion 110a of a route 110. Although shown in FIG. 1 as a pedestrian, user 104 can also be riding a bicycle, driving in another vehicle, riding as a passenger in another vehicle, etc. Autonomous vehicle 102 follow user 104 based on a variety of different methods. For example, autonomous vehicle 102 can determine a position of user 104 based on a position signal (e.g., Global Positioning System (GPS) signal) user device associated with user 104 (e.g., a mobile phone). As another example, autonomous vehicle 102 can communicate with the user device to determine the position of the user. The autonomous vehicle 102 can utilize a wide variety of communication methods including, but not limited to, Bluetooth, Wi-Fi, cellular communications, etc. As yet another example, autonomous vehicle 102 can utilize sensors (e.g., sensor systems 504-506) to detect and track user 104. In other words, autonomous vehicle 102 can utilize data from sensors to use computer vision to detect and track user 104. For example, autonomous vehicle 102 can receive camera and/or LiDAR data from sensors, interpret the data, and track user 104 based on the data and/or interpreted data.

As autonomous vehicle 102 follows user 104, autonomous vehicle 102 can detect that user 104 has entered and/or is entering an area 120 inaccessible to autonomous vehicle. As shown in FIG. 1, area 120 can be a bike lane, pedestrian area, and/or any other area that autonomous vehicle 102 cannot and/or is not permitted to enter (e.g., based on traffic rules and/or regulations). Autonomous vehicle 102 can then determine, based on area 120, a meeting point 130 to reconvene with user 104. For example, area 120 may be a bike route being a straight line and having two ends, an entry and an exit. Autonomous vehicle 102 can then determine, based on the entry and exit, that user 104 is likely to continue through area 120 to the exit. Thus, autonomous vehicle 102 can select the exit of area 120 as meeting point 130.

Similarly, user 104 can request to access autonomous vehicle 102 at any given time. For example, user 104 may send a request through a ridesharing app (e.g., ridesharing app 570). The request may have a specified time and/or location (e.g., meeting point 130). Autonomous vehicle 102 can receive the request and navigate to the specified time and/or location.

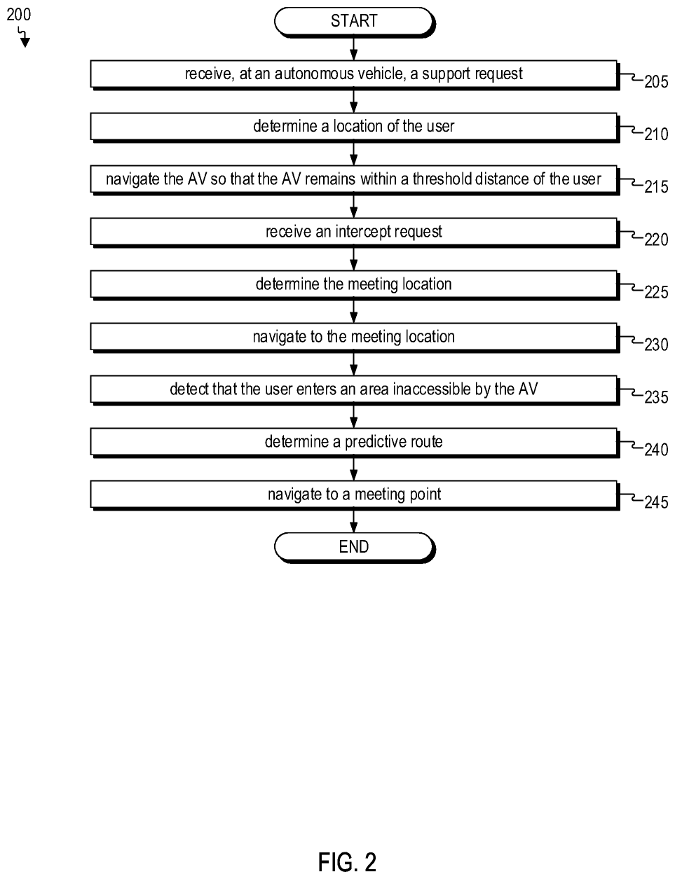

FIG. 2 illustrates an example method 200 for an autonomous vehicle navigating based on a follow-along preference. Although the example method 200 depicts a particular sequence of operations, the sequence may be altered without departing from the scope of the present disclosure. For example, some of the operations depicted may be performed in parallel or in a different sequence that does not materially affect the function of the method 200. In other examples, different components of an example device or system that implements the method 200 may perform functions at substantially the same time or in a specific sequence.

At step 205, method 200 includes receiving, at an autonomous vehicle, a support request at step 205. For example, autonomous vehicle 102 can receive a support request directly from a user and/or user device or through a remote computing system (e.g., remote computing system 550). The support request can specify a follow-along routing preference specified by the user. Furthermore, the follow-along routing preference can further specify a threshold distance that the autonomous vehicle should remain within from the user. For example, user 104 may request that autonomous vehicle 102 remain positioned within 1 mile from user 104. Additionally, the support request can specify a type of autonomous vehicle. For example, the support request can specify a type of vehicle, such as a truck, a van, multiple vehicles, etc. A ridesharing service can receive the support request and dispatch and forward the support request to an autonomous vehicle of the specified type. Thus, the autonomous vehicle that is dispatched and/or receives the support request would then be the type of vehicle specified in the support request.

At step 210, method 200 includes determining a location of the user. For example, the autonomous vehicle illustrated in FIG. 1 may determine a location of the user. In some embodiments, the location of the user is determined based on at least one of a location of a user device associated with the user or image tracking of the user.

At step 215, method 200 includes navigating the autonomous vehicle so that the autonomous vehicle remains positioned within a threshold distance of the user. Furthermore, the autonomous vehicle can be configured to remain positioned within a threshold distance of the user, while also obeying relevant road rules and regulations.

In some embodiments, at step 220, method 200 includes receiving an intercept request from the user. For example, the autonomous vehicle may receive an intercept request from the user. In some embodiments, the intercept request includes a meeting location and/or time.

In some embodiments, at step 225, method 200 includes determining the meeting location and/or time. For example, the autonomous vehicle can utilize the meeting location and/or time specified by the intercept request. In some embodiments, the intercept request may not specify either the location or the time. In these embodiments, the autonomous vehicle can determine that the intercept request specifies the time to be as soon as possible and at the current location of the user device.

In some embodiments, at step 230, method 200 includes navigating to the meeting location. For example, the autonomous vehicle can navigate to the meeting location at the specified time.

In some embodiments, at step 235, method 200 includes detecting that the user enters an area inaccessible by the autonomous vehicle according to regulations. For example, the autonomous vehicle (e.g., via sensors 504-506) may detect that the user enters an area inaccessible by the autonomous vehicle according to regulations.

In some embodiments, at step 240, method 200 includes determining a predictive route of the user based on the area. For example, the autonomous vehicle may determine a predictive route of the user based on the area and/or characteristics of the area (e.g., ingress and egress points of the area). Furthermore, the autonomous vehicle can select a meeting point based on the predictive route and the area.

In some embodiments, at step 245, method 200 includes navigating to a meeting point based on the predictive route. For example, the autonomous vehicle may navigate to a meeting point based on the predictive route. In some embodiments, the meeting point may be positioned outside of the area.

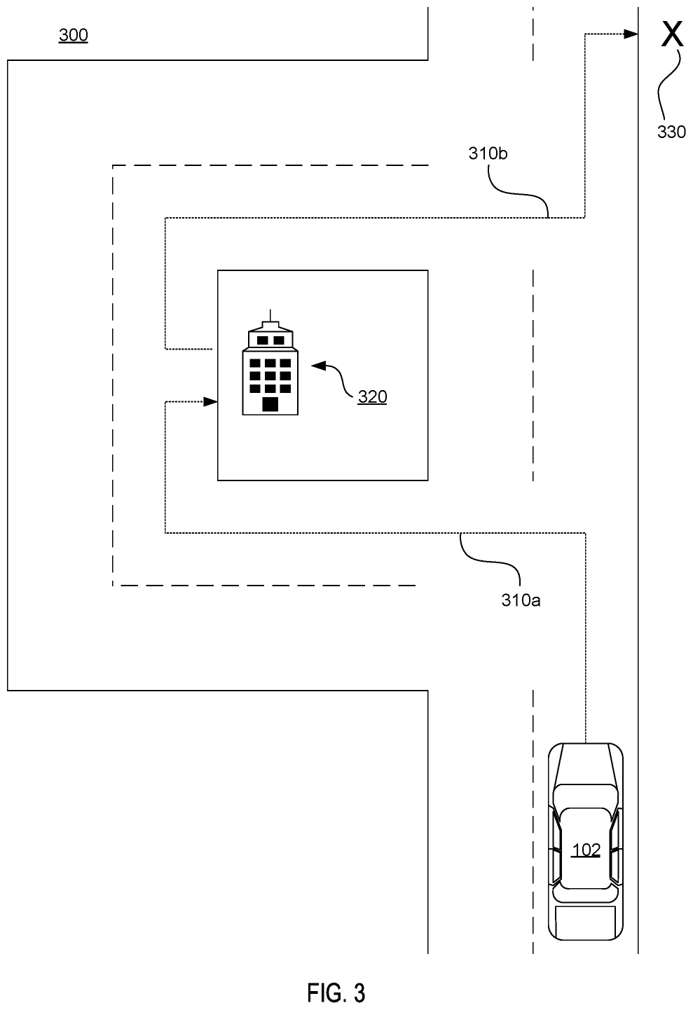

FIG. 3 illustrates an environment 300 having an autonomous vehicle 102 and a user 104. User 104 may request use of autonomous vehicle 102 for logistical support. For example, user 104 may desire to utilize autonomous vehicle 102 as a storage vehicle, or vehicle for moving items, etc. The user 104 can send the request via a user device having a ridesharing app (e.g., ridesharing app 570). A remote computing system (e.g., remote computing system 550) can receive the request (e.g., via rideshare service 558) and dispatch a suitable autonomous vehicle, such as autonomous vehicle 102. In some embodiments, autonomous vehicle 102 can be one autonomous vehicle in an autonomous vehicle fleet. Furthermore, the autonomous vehicle fleet can have various different models of autonomous vehicles, so that one or more autonomous vehicle models can be suitable for various user requests based on cabin size, storage size, distance from a start point to a destination, etc. Autonomous vehicle 102 can then receive the request and navigate to the start point and/or user 104.

The request can specify a flexible routing preference. The flexible routing preference can be configured to permit autonomous vehicle 102 to take any route to arrive at a specified destination at or by a specified time. Thus, the request can include a specified location 330 and/or time for autonomous vehicle 102 to arrive by. Furthermore, the flexible routing preference permits autonomous vehicle 102 to deviate away from the user. Additionally, the flexible routing preference can optimize routing for a wide variety of different factors including, but not limited to, battery level, power consumption and/or efficiency, traffic, construction, wear and tear from specific roads, etc.

As further shown in FIG. 3, autonomous vehicle 102 can be configured to flexibly navigate a route. In some embodiments, autonomous vehicle 102 can conduct other activities that can be accomplished prior to the autonomous vehicle arriving at a specified location and/or at a specified time. For example, autonomous vehicle 102 can generate a route 310a to navigate to a repair and/or maintenance facility 320 for vehicle maintenance (e.g., recharging battery). As another example, autonomous vehicle 102 can conduct additional ridesharing services to the same user and/or other users prior to arriving at the specified location by the specified time. After conducting other activities, autonomous vehicle 102 can generate another route 310b to arrive at the specified location 330 at or prior to the specified time. In some embodiments, autonomous vehicle 102 can forecast an estimated amount of time required for autonomous vehicle 102 to complete other activities and generate routes 310a, 310b to arrive at specified location 330 at or prior to the specified time.

Like the follow along preference, the flexible routing preference can be configured to cause the autonomous vehicle to handle an intercept request. Again, user 104 can request to access autonomous vehicle 102 at any given time. For example, user 104 may send a request through a ridesharing app (e.g., ridesharing app 570). The request may have a specified time and/or location (e.g., meeting point 130). Autonomous vehicle 102 can receive the request and navigate to the specified time and/or location.

It is to be understood that autonomous vehicle 102 can be configured to execute both the follow along preference and the flexible routing preference. Furthermore, aspects of each preference can be incorporated with the other preference. For example, the flexible routing preference may also specify a threshold distance for which the autonomous vehicle should remain within. Thus, the autonomous vehicle can execute other activities as long as the autonomous vehicle remains within the threshold distance.

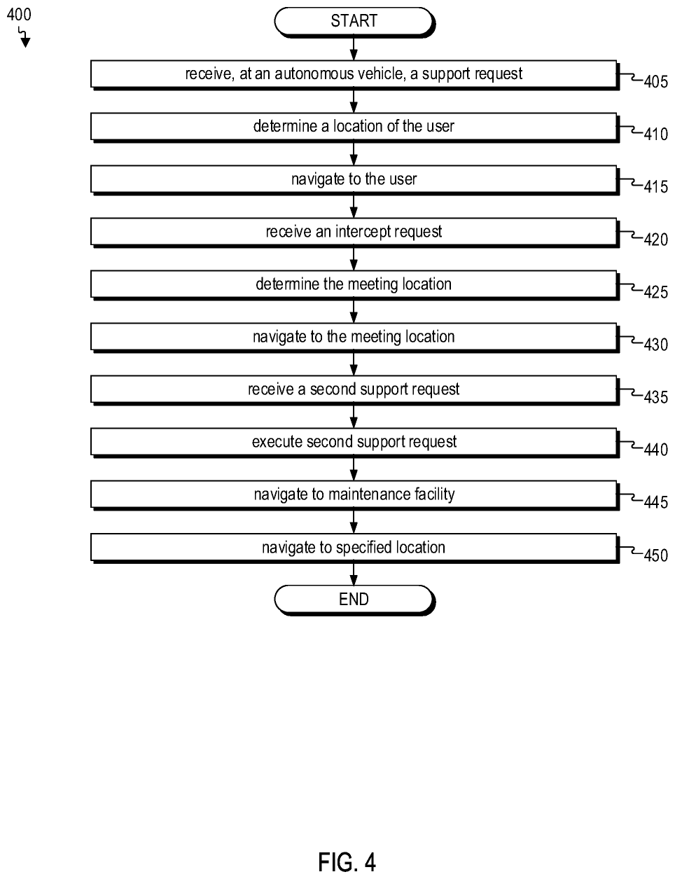

FIG. 4 illustrates an example method 400 for an autonomous vehicle navigating based on a flexible routing preference. Although the example method 400 depicts a particular sequence of operations, the sequence may be altered without departing from the scope of the present disclosure. For example, some of the operations depicted may be performed in parallel or in a different sequence that does not materially affect the function of the method 400. In other examples, different components of an example device or system that implements the method 400 may perform functions at substantially the same time or in a specific sequence.

At step 405, method 400 includes receiving, at an autonomous vehicle, a support request. For example, autonomous vehicle 102 can receive a support request directly from a user and/or user device or through a remote computing system (e.g., remote computing system 550). The support request can specify a flexible routing preference specified by the user. Furthermore, the flexible routing preference can further specify a location and/or a time for the autonomous vehicle to arrive at or by. Additionally, the support request can specify a type of autonomous vehicle. For example, the support request can specify a type of vehicle, such as a truck, a van, and/or multiple vehicles, etc. A ridesharing service can receive the support request and dispatch and/or forward the support request to an autonomous vehicle of the specified type. Thus, the autonomous vehicle that is dispatched and/or receives the support request would then be the type of vehicle specified in the support request.

At step 410, method 400 includes determining a location of the user. For example, the location of the user can be determined using GPS coordinate information for a user device associated with the user (e.g., a smartphone or other mobile processing device). In other aspects, various other radio-frequency (RF) based position location determinations may be made, for example, using one or more radio chipsets (e.g., a 5G radio) on once or more devices associated with the user.

At step 415, method 400 includes navigating to the user.

In some embodiments, at step 420, method 400 includes receiving an intercept request from the user. For example, the autonomous vehicle may receive an intercept request from the user. In some embodiments, the intercept request includes a meeting location and/or time.

In some embodiments, at step 425, method 400 includes determining the meeting location and/or time. For example, the autonomous vehicle can utilize the meeting location and/or time specified by the intercept request. In some embodiments, the intercept request may not specify either the location or the time. In these embodiments, the autonomous vehicle can determine that the intercept request is as soon as possible and at the current location of the user device.

In some embodiments, at step 430, method 400 includes navigating to the meeting location. For example, the autonomous vehicle can navigate to the meeting location at the specified time.

In some embodiments, at step 435, method 400 includes receiving a second support request. The second support request may be from the same user and/or another user.

In some embodiments, at step 440, method 400 includes executing and/or fulfilling the second support request. For example, a second user may send the second support request and specify a follow along routing. The autonomous vehicle can then fulfill the second support request and follow the second user according to method 200.

In some embodiments, at step 445, method 400 includes navigating to a maintenance facility. For example, the autonomous vehicle may be low on battery or need to change tires. Thus, prior to the specified time, the autonomous vehicle can navigate to a recharging station to recharge a battery of the autonomous vehicle.

At step 450, method 400 includes navigating to the specified location at or prior to the specified time.

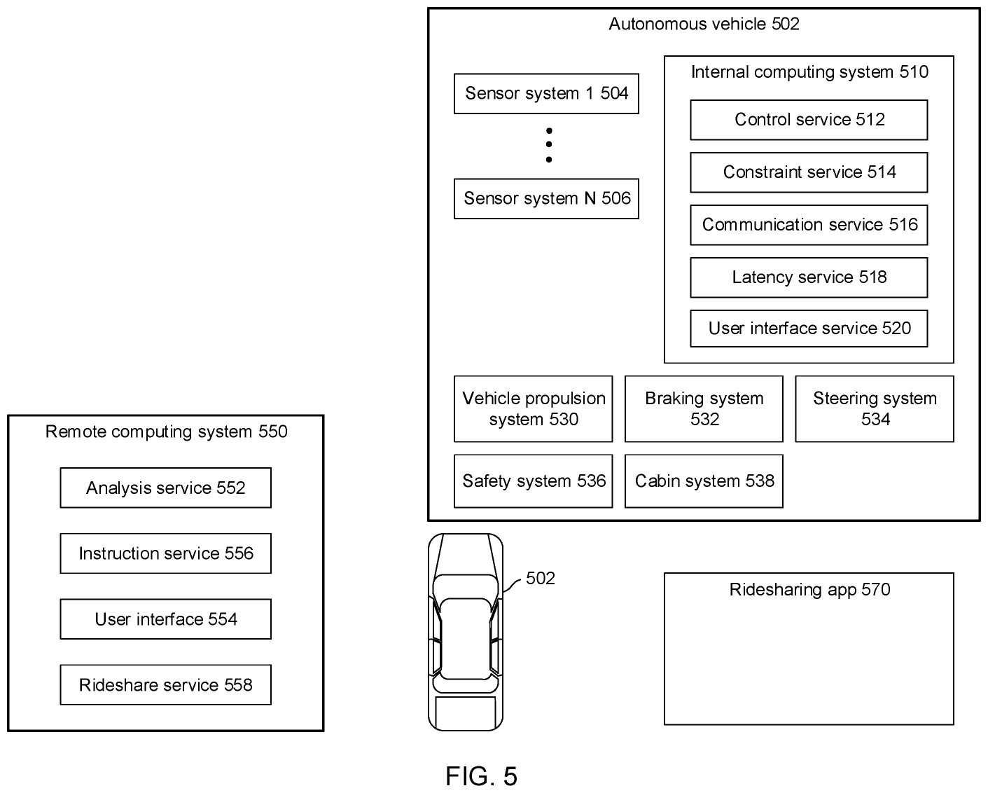

FIG. 5 illustrates environment 500 that includes an autonomous vehicle 502 in communication with a computing system 550.

The autonomous vehicle 502 can navigate about roadways without a human driver based upon sensor signals output by sensor systems 504-506 of the autonomous vehicle 502. The autonomous vehicle 502 includes a plurality of sensor systems 504-506 (a first sensor system 502 through an Nth sensor system 504). The sensor systems 504-506 are of different types and are arranged about the autonomous vehicle 502. For example, the first sensor system 504 may be a camera sensor system and the Nth sensor system 506 may be a lidar sensor system. Other exemplary sensor systems include radar sensor systems, global positioning system (GPS) sensor systems, inertial measurement units (IMU), infrared sensor systems, laser sensor systems, sonar sensor systems, and the like.

The autonomous vehicle 502 further includes several mechanical systems that are used to effectuate appropriate motion of the autonomous vehicle 502. For instance, the mechanical systems can include but are not limited to, a vehicle propulsion system 530, a braking system 532, and a steering system 534. The vehicle propulsion system 530 may include an electric motor, an internal combustion engine, or both. The braking system 532 can include an engine brake, brake pads, actuators, and/or any other suitable componentry that is configured to assist in decelerating the autonomous vehicle 502. The steering system 534 includes suitable componentry that is configured to control the direction of movement of the autonomous vehicle 502 during navigation.

The autonomous vehicle 502 further includes a safety system 536 that can include various lights and signal indicators, parking brake, airbags, etc. The autonomous vehicle 502 further includes a cabin system 538 that can include cabin temperature control systems, in-cabin entertainment systems, etc.

The autonomous vehicle 502 additionally comprises an internal computing system 510 that is in communication with the sensor systems 504-506 and the mechanical systems 530, 532, 534. The internal computing system includes at least one processor and at least one memory having computer-executable instructions that are executed by the processor. The computer-executable instructions can make up one or more services responsible for controlling the autonomous vehicle 502, communicating with remote computing system 550, receiving inputs from passengers or human co-pilots, logging metrics regarding data collected by sensor systems 504-506 and human co-pilots, etc.

The internal computing system 510 can include a control service 512 that is configured to control operation of the vehicle propulsion system 506, the braking system 508, the steering system 510, the safety system 536, and the cabin system 538. The control service 512 receives sensor signals from the sensor systems 502-504 as well communicates with other services of the internal computing system 510 to effectuate operation of the autonomous vehicle 502. In some embodiments, control service 512 may carry out operations in concert one or more other systems of autonomous vehicle 502.

The internal computing system 510 can also include a constraint service 514 to facilitate safe propulsion of the autonomous vehicle 502. The constraint service 516 includes instructions for activating a constraint based on a rule-based restriction upon operation of the autonomous vehicle 502. For example, the constraint may be a restriction upon navigation that is activated in accordance with protocols configured to avoid occupying the same space as other objects, abide by traffic laws, circumvent avoidance areas, etc. In some embodiments, the constraint service can be part of the control service 512.

The internal computing system 510 can also include a communication service 516. The communication service can include both software and hardware elements for transmitting and receiving signals from/to the remote computing system 550. The communication service 516 is configured to transmit information wirelessly over a network, for example, through an antenna array that provides personal cellular (long-term evolution (LTE), 3G, 5G, etc.) communication.

In some embodiments, one or more services of the internal computing system 510 are configured to send and receive communications to remote computing system 550 for such reasons as reporting data for training and evaluating machine learning algorithms, requesting assistance from remoting computing system or a human operator via remote computing system, software service updates, ridesharing pickup and drop off instructions etc.

The internal computing system 510 can also include a latency service 518. The latency service 518 can utilize timestamps on communications to and from the remote computing system 550 to determine if a communication has been received from the remote computing system 550 in time to be useful. For example, when a service of the internal computing system 510 requests feedback from remote computing system 550 on a time-sensitive process, the latency service 518 can determine if a response was timely received from remote computing system 550 as information can quickly become too stale to be actionable. When the latency service 518 determines that a response has not been received within a threshold, the latency service 518 can enable other systems of autonomous vehicle 502 or a passenger to make necessary decisions or to provide the needed feedback.

The internal computing system 510 can also include a user interface service 520 that can communicate with cabin system 538 in order to provide information or receive information to a human co-pilot or human passenger. In some embodiments, a human co-pilot or human passenger may be required to evaluate and override a constraint from constraint service 514, or the human co-pilot or human passenger may wish to provide an instruction to the autonomous vehicle 502 regarding destinations, requested routes, or other requested operations.

As described above, the remote computing system 550 is configured to send/receive a signal from the autonomous vehicle 540 regarding reporting data for training and evaluating machine learning algorithms, requesting assistance from remoting computing system or a human operator via the remote computing system 550, software service updates, ridesharing pickup and drop off instructions, etc.

The remote computing system 550 includes an analysis service 552 that is configured to receive data from autonomous vehicle 502 and analyze the data to train or evaluate machine learning algorithms for operating the autonomous vehicle 502. The analysis service 552 can also perform analysis pertaining to data associated with one or more errors or constraints reported by autonomous vehicle 502.

The remote computing system 550 can also include a user interface service 554 configured to present metrics, video, pictures, sounds reported from the autonomous vehicle 502 to an operator of remote computing system 550. User interface service 554 can further receive input instructions from an operator that can be sent to the autonomous vehicle 502.

The remote computing system 550 can also include an instruction service 556 for sending instructions regarding the operation of the autonomous vehicle 502. For example, in response to an output of the analysis service 552 or user interface service 554, instructions service 556 can prepare instructions to one or more services of the autonomous vehicle 502 or a co-pilot or passenger of the autonomous vehicle 502.

The remote computing system 550 can also include a rideshare service 558 configured to interact with ridesharing applications 570 operating on (potential) passenger computing devices. The rideshare service 558 can receive requests to be picked up or dropped off from passenger ridesharing app 570 and can dispatch autonomous vehicle 502 for the trip. The rideshare service 558 can also act as an intermediary between the ridesharing app 570 and the autonomous vehicle wherein a passenger might provide instructions to the autonomous vehicle to 502 go around an obstacle, change routes, honk the horn, etc.

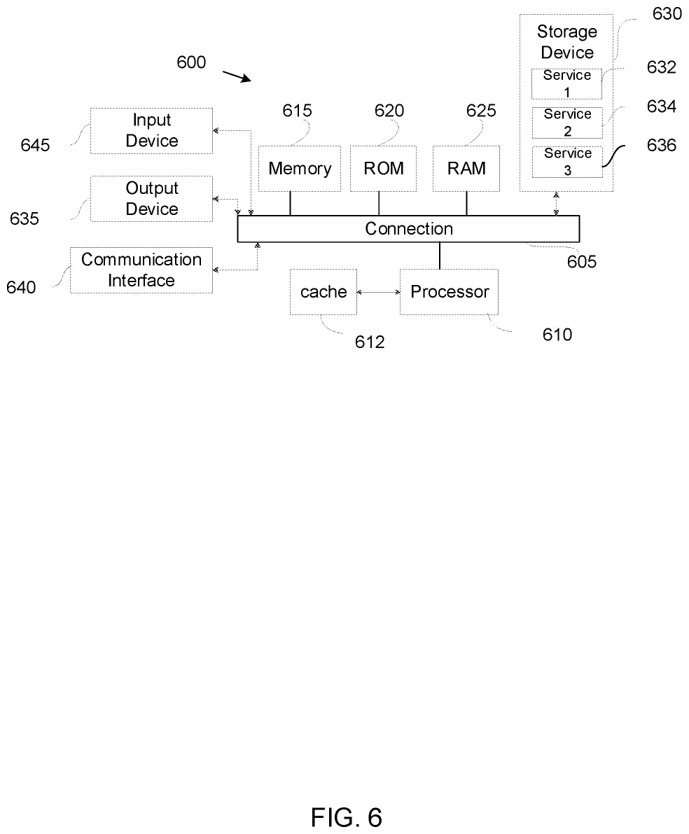

FIG. 6 shows an example of computing system 600, which can be for example any computing device making up internal computing system 510, remote computing system 550, or any component thereof in which the components of the system are in communication with each other using connection 605. Connection 605 can be a physical connection via a bus, or a direct connection into processor 610, such as in a chipset architecture. Connection 605 can also be a virtual connection, networked connection, or logical connection.

In some embodiments, computing system 600 is a distributed system in which the functions described in this disclosure can be distributed within a datacenter, multiple data centers, a peer network, etc. In some embodiments, one or more of the described system components represents many such components each performing some or all of the function for which the component is described. In some embodiments, the components can be physical or virtual devices.

Example system 600 includes at least one processing unit (CPU or processor) 610 and connection 605 that couples various system components including system memory 615, such as read-only memory (ROM) 620 and random access memory (RAM) 625 to processor 610. Computing system 600 can include a cache of high-speed memory 612 connected directly with, in close proximity to, or integrated as part of processor 610.

Processor 610 can include any general purpose processor and a hardware service or software service, such as services 632, 634, and 636 stored in storage device 630, configured to control processor 610 as well as a special-purpose processor where software instructions are incorporated into the actual processor design. Processor 610 may essentially be a completely self-contained computing system, containing multiple cores or processors, a bus, memory controller, cache, etc. A multi-core processor may be symmetric or asymmetric.

To enable user interaction, computing system 600 includes an input device 645, which can represent any number of input mechanisms, such as a microphone for speech, a touch-sensitive screen for gesture or graphical input, keyboard, mouse, motion input, speech, etc. Computing system 600 can also include output device 635, which can be one or more of a number of output mechanisms known to those of skill in the art. In some instances, multimodal systems can enable a user to provide multiple types of input/output to communicate with computing system 600. Computing system 600 can include communications interface 640, which can generally govern and manage the user input and system output. There is no restriction on operating on any particular hardware arrangement, and therefore the basic features here may easily be substituted for improved hardware or firmware arrangements as they are developed.

Storage device 630 can be a non-volatile memory device and can be a hard disk or other types of computer readable media which can store data that are accessible by a computer, such as magnetic cassettes, flash memory cards, solid state memory devices, digital versatile disks, cartridges, random access memories (RAMs), read-only memory (ROM), and/or some combination of these devices.

The storage device 630 can include software services, servers, services, etc., that when the code that defines such software is executed by the processor 610, it causes the system to perform a function. In some embodiments, a hardware service that performs a particular function can include the software component stored in a computer-readable medium in connection with the necessary hardware components, such as processor 610, connection 605, output device 635, etc., to carry out the function.

For clarity of explanation, in some instances, the present technology may be presented as including individual functional blocks including functional blocks comprising devices, device components, steps or routines in a method embodied in software, or combinations of hardware and software.

Any of the steps, operations, functions, or processes described herein may be performed or implemented by a combination of hardware and software services or services, alone or in combination with other devices. In some embodiments, a service can be software that resides in memory of a client device and/or one or more servers of a content management system and perform one or more functions when a processor executes the software associated with the service. In some embodiments, a service is a program or a collection of programs that carry out a specific function. In some embodiments, a service can be considered a server. The memory can be a non-transitory computer-readable medium.

In some embodiments, the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Methods according to the above-described examples can be implemented using computer-executable instructions that are stored or otherwise available from computer-readable media. Such instructions can comprise, for example, instructions and data which cause or otherwise configure a general purpose computer, special purpose computer, or special purpose processing device to perform a certain function or group of functions. Portions of computer resources used can be accessible over a network. The executable computer instructions may be, for example, binaries, intermediate format instructions such as assembly language, firmware, or source code. Examples of computer-readable media that may be used to store instructions, information used, and/or information created during methods according to described examples include magnetic or optical disks, solid-state memory devices, flash memory, USB devices provided with non-volatile memory, networked storage devices, and so on.

Devices implementing methods according to these disclosures can comprise hardware, firmware and/or software, and can take any of a variety of form factors. Typical examples of such form factors include servers, laptops, smartphones, small form factor personal computers, personal digital assistants, and so on. The functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are means for providing the functions described in these disclosures.

What is claimed is:

1. A computer-implemented method comprising:
receiving, at an autonomous vehicle (AV), a support request, wherein the support request specifies a follow-along routing preference specified by the user; and
in response to the follow-along routing preference specified by the user, further performing operations for:
determining a location of the user; and
navigating the AV so that the AV remains positioned within a threshold distance of the user.

2. The computer-implemented method of claim 1, wherein the support request specifies a type of AV.

3. The computer-implemented method of claim 1, wherein the operations further include:
receiving an intercept request from the user, the intercept request including a meeting location;
determining the meeting location; and
navigating to the meeting location.

4. The computer-implemented method of claim 1, wherein the operations further include:
sending an AV location of the AV to a user device associated with the user.

5. The computer-implemented method of claim 1, wherein the operations further include:
detecting that the user enters an area inaccessible by the AV;
determining a predictive route of the user based on the area; and
navigating to a meeting point based on the predictive route, wherein the meeting point is not in the area.

6. The computer-implemented method of claim 1, wherein the location of the user is determined based on at least one of a location of a user device associated with the user or image tracking of the user.

7. The computer-implemented method of claim 1, wherein the follow-along routing preference further specifies the threshold distance.

8. A non-transitory computer-readable storage medium comprising instructions stored therein, which when executed by one or more processors cause the processors to perform operations, comprising:
receive, at an autonomous vehicle (AV), a support request, wherein the support request specifies a follow-along routing preference specified by the user; and
in response to the follow-along routing preference specified by the user, further perform operations to:
determine a location of the user; and
navigate the AV so that the AV remains positioned within a threshold distance of the user.

9. The non-transitory computer-readable storage medium of claim 8, wherein the support request specifies a type of AV, and wherein the AV is an AV of the specified type.

10. The non-transitory computer-readable storage medium of claim 8, wherein the operations further include:
receive an intercept request from the user, the intercept request including a meeting location;
determine the meeting location; and
navigate to the meeting location.

11. The non-transitory computer-readable storage medium of claim 8, wherein the operations further include:
send an AV location of the AV to a user device associated with the user.

12. The non-transitory computer-readable storage medium of claim 8, wherein the operations further include:
detect that the user enters an area inaccessible by the AV;
determine a predictive route of the user based on the area; and
navigate to a meeting point based on the predictive route, wherein the meeting point is not in the area.

13. The non-transitory computer-readable storage medium of claim 8, wherein the location of the user is determined based on at least one of a location of a user device associated with the user or image tracking of the user.

14. The non-transitory computer-readable storage medium of claim 8, wherein the follow-along routing preference further specifies the threshold distance.

15. A system comprising:
one or more processors; and
one or more memories storing instructions thereon, which when executed by the one or more processors, cause the one or more processors to perform operations comprising:
receive, at an autonomous vehicle (AV), a support request, wherein the support request specifies a follow-along routing preference specified by the user; and
in response to the follow-along routing preference specified by the user, further perform operations to:
determine a location of the user; and
navigate the AV so that the AV remains positioned within a threshold distance of the user.

16. The system of claim 15, wherein the support request specifies a type of AV, and wherein the AV is an AV of the specified type.

17. The system of claim 15, wherein the operations further include:
receive an intercept request from the user, the intercept request including a meeting location;
determine the meeting location; and
navigate to the meeting location.

18. The system of claim 15, wherein the operations further include:
send an AV location of the AV to a user device associated with the user.

19. The system of claim 15, wherein the operations further include:
detect that the user enters an area inaccessible by the AV;
determine a predictive route of the user based on the area; and
navigate to a meeting point based on the predictive route, wherein the meeting point is not in the area.

20. The system of claim 15, wherein the location of the user is determined based on at least one of a location of a user device associated with the user or image tracking of the user.
